(19) United States
(12) Patent Application Publication
(10) Pub. No.: US 2026/0226680 A1
(43) Pub. Date: Aug. 6, 2026

(54) PULP MIXTURE

(71) Applicant: Södra Skogsägarna ekonomisk förening, Växjö (SE)

(72) Inventors: Fredrik Wernersson Brodin, Kungsbacka (SE); Harald Brelid, Göteborg (SE); Espen Ribe, Varberg (SE); Jonas Wetterling, Mölndal (SE)

(73) Assignee: Södra Skogsägarna ekonomisk förening, Växjö (SE)

(21) Appl. No.: 19/153,119

(22) PCT Filed: Feb. 5, 2024
(86) PCT No.: PCT/EP2024/052797

§ 371 Date: Aug. 1, 2025

(30) Foreign Application Priority Data
Feb. 6, 2023 (SE) 2350111-7

(51) Int. Cl. D21C 9/10; D21C 1/06; D21C 5/00; D21C 9/02; D21C 9/147; D21C 9/18

(52) U.S. Cl. CPC D21C 9/1057; D21C 1/06; D21C 5/00; D21C 9/02; D21C 9/1063; D21C 9/147; D21C 9/18; D10B 2101/02; D10B 2201/01

(57) ABSTRACT

The present invention relates to a method for production of a pulp mixture of wood pulp and agricultural material. The method comprises the steps of: a) providing wood chips; b) providing agricultural crop/residue; c) extracting the agricultural crop/residue in an alkaline solution thus obtaining a slurry of silica-depleted agro-fibers and an extraction liquor comprising hemicellulose, silica, and residual alkali; d) separating the silica-depleted agro-fibers from the extraction liquor; e) liberating wood pulp fibers by treating the wood chips with cooking chemicals in a wood cooking process having a recovery cycle for cooking chemicals; f) adding the separated silica-depleted agro-fibers to the wood pulp fibers thus obtaining a pulp mixture; g) oxygen delignifying the liberated wood pulp fibers; and h) bleaching the pulp mixture in a multistage bleaching sequence comprising at least one alkaline bleaching stage, wherein steps c) and d) occur before step f) to avoid contamination of the cooking chemicals by silica from the agricultural crop/residue thereby enabling recovery of the cooking chemicals.

### FIELD OF THE INVENTION

The present inventive concept relates to a pulp mixture of wood pulp fibers and agricultural material. The present inventive concept also relates to a method for production of a pulp mixture of wood pulp and agricultural material.

### BACKGROUND

Pulp is a lignocellulosic fibrous material prepared by chemically or mechanically separating cellulose fibers from wood, fiber crops, wastepaper, or rags. Mixed with water and other chemicals, pulp is the major raw material used in for example papermaking.

Today, the most common source for pulp for papermaking is based on wood. However, the demand for pulp increases at the same time as many countries have limited accessibility to forest resources. As a result, the interest for non-wood alternatives in paper making, such as agricultural materials is increasing.

Document WO2011072718 describes a process for forming a pulp mixture wherein agricultural crop/residues or pre-processed agricultural crop/residues are introduced to wood material in a wood pulping process. The idea is based on the possibility of taking advantage of the xylan adsorption that the agro-based raw material provides and the positive effects xylan provides on the properties of the pulp. However, a challenge with the agro-based materials which is not addressed in WO2011072718 is the fact that agro-based raw material may contain high levels of silicon compounds, such as silicon dioxide compounds, which in a recovery cycle of a modern sulfate mill may entail major risks linked to process disturbances, such as scaling in the evaporation and accumulation of silica in the lime cycle.

If a composition containing a high silica containing feedstock is added to the closed cycle of a kraft pulp mill, e.g. before or during the wood cooking process or in the oxygen delignification step, a very large amount of silica would be introduced in the process chemicals. Such a procedure would be technically unviable and economically unsustainable in a kraft pulp mill with a chemical recovery cycle.

There is therefore a need for an improved method for production of a pulp mixture of wood pulp and agricultural material.

### SUMMARY

It is an object of the present inventive concept to overcome the above-identified problem, and to provide an improved method for production of a pulp mixture of wood pulp and agricultural material. The method is aimed to limit and control silica intake to the recovery cycle.

According to a first aspect of the inventive concept, this and other objects are achieved by a method for production of a pulp mixture of wood pulp and agricultural material. The method comprises the steps of:
a) providing wood chips;
b) providing agricultural crop/residue;
c) extracting the agricultural crop/residue in an alkaline solution thus obtaining a slurry of silica-depleted agro-fibers and an extraction liquor comprising hemicellulose, silica, and residual alkali;
d) separating the silica-depleted agro-fibers from the extraction liquor;
e) liberating wood pulp fibers by treating the wood chips with cooking chemicals in a wood cooking process having a recovery cycle for cooking chemicals;
f) adding the separated silica-depleted agro-fibers to the wood pulp fibers thus obtaining a pulp mixture;
g) oxygen delignifying the liberated wood pulp fibers; and
h) bleaching the pulp mixture in a multistage bleaching sequence comprising at least one alkaline bleaching stage,
wherein steps c) and d) occur before step f) to avoid contamination of the cooking chemicals by silica from the agricultural crop/residue thereby enabling recovery of the cooking chemicals.

The method comprises treating wood chips with cooking chemicals in a wood cooking process to liberate wood pulp fibers. For economic and environmental reasons, the wood cooking chemicals are regenerated in a recovery cycle. This means that it is important to minimize the introduction of silica from the agricultural crop/residue which otherwise would severely disturb the process for the recycling of cooking chemicals. The process according to the inventive concept is at least partly based on the understanding that by doing a pre-extraction of agro-based raw material, which is usually rich in silica, under relatively mild conditions for higher yield and by adding solid residue, i.e. the fibers, to the wood fibers in a closed-cycle part of a pulp mill, co-processing of the wood fibers and the silica depleted agricultural-based fibers are enabled at the same time as contamination of cooking chemicals by silica is avoided. Hereby, a resource-efficient recovery of the wood cooking chemicals is enabled.

Wood fibers may be referred to as fibers originating from wood material.

The term agro-fibers should be interpreted as agricultural-based fibers or fibers based on agricultural crop and/or residue.

As used herein, the term “wood cooking chemicals” may refer to the white liquor used in a kraft process. The wood cooking process may be a kraft process. Alternatively, the wood cooking process may be a sulphite or a soda process.

As mentioned above, agricultural crop/residue may contain high levels of silica (which may cause contamination of the process chemicals). Thus, the agricultural crop/residue may be defined as high silica containing agricultural crop/residue or silica-rich agricultural crop/residue. Typically, the agricultural crop/residue may have a silica content of at least 1000 ppm, preferably at least 2000 ppm, more preferably at least 4000 ppm, most preferably at least 10000 ppm. It should be noted that the purpose of the inventive concept is not necessarily to use a raw material with as high a silica content as possible, but rather to provide a method applicable to raw materials with high silica content. The agricultural crop/residue may comprise oat husk and/or straw, such as wheat straw. The silica content in, for example, wheat straw and oat hulls may be 3-7% of the total chemical composition of the dried material, corresponding to 30 000-70 000 ppm.

The higher the silica content is, the more severe process disturbances in the chemical recovery process will arise. The magnitude of the process disturbances depends on the silica content of the agricultural crop/residue and the amount/share of agricultural crop/residue added to the liberated wood fibers.

The silica depleted agricultural-based fibers may be added to the wood pulp fibers prior to or during step g). Hereby, the silica-depleted agro-fibers may be co-processed with the wood pulp fibers in the steps of oxygen delignification and bleaching. In case the silica-depleted agro-fibers are added to the liberated wood pulp fibers prior to and/or during the step of oxygen delignification, the wood pulp fibers may be subjected to both oxygen delignification and bleaching together with the silica-depleted agro-fibers. This means that the oxygen delignification of step g) is performed on the pulp mixture and not only on the liberated wood pulp fibers. It may be advantageous to oxygen delignify and/or bleach the wood pulp fibers and the silica depleted fibers together in the same method. Alternatively, the silica-depleted agro-fibers may be added to the wood pulp fibers after the step of oxygen delignification but prior to the bleaching. In other words, step f) may occur between step g) and step h).

The method may further comprise a step of:
i) adding, at the earliest during step h), the extraction liquor to the wood pulp fibers to enable simultaneous bleaching and hemicellulose sorption. Hereby, the hemicellulose in the extraction liquor may be utilized for xylan sorption. It has surprisingly been found that performing xylan sorption in a bleaching step (which have a different main purpose) works very well even though there may be limited opportunities to control and optimize the conditions for xylan sorption.

A technical effect of adding the extraction liquor to the wood pulp fibers is that a pulp mixture with improved strength properties may be obtained. The addition may be conducted during the alkaline bleaching. By adding the extraction liquor at the earliest during the alkaline bleaching, contaminating of the process chemicals in the wood cooking process or in the oxygen delignification process is avoided. Furthermore, replacement of fresh alkali with residual alkali from the alkaline extraction process is enabled. Hereby, the amount of fresh alkali during bleaching is reduced.

It should be noted that the multistage bleaching sequence may comprise one or several alkaline bleaching stages. The extraction liquor may thus be added in any one of the one or several alkaline bleaching stages.

The silica-depleted agro-fibers and the extraction liquor are separated prior to addition of the silica-depleted agro-fibers to the wood pulp fibers. Step d) may comprise dewatering and/or washing the slurry of silica-depleted agro-fibers and extraction liquor. A technical effect of the separation is that the purity of the silica-depleted agro-fibers is improved. An example of separation is to separate the silica-depleted agro-fibers from the extraction liquor by washing, i.e. so-called displacement washing, before the silica-depleted agro-fibers are added to the wood pulp fibers. Furthermore, the silica-depleted agro-fibers and the extraction liquor may be separated in two or more steps; e.g. the silica-depleted agro-fibers and the extraction liquor may be subjected to a first dewatering step resulting in a first purification of the silica depleted agro-fibers, followed by dilution, and possibly a second dewatering step which further purifies the silica depleted agro-fibers.

The method may further comprise a step of:
j) leaching and/or washing the agricultural crop/residue to remove water soluble elements from the agricultural crop/residue, wherein step j) occurs before step c).

A technical effect of removing water soluble elements prior to the extraction is that the purity of the silica depleted agro-fibers may be increased and alkali consumption during the following extraction may be decreased.

The separated silica-depleted agro-fibers may typically have a silica content of no more than 3000 mg silica/kg dry material, preferably no more than 1000 mg silica/kg dry material, more preferably no more than 500 mg silica/kg dry material.

In order to avoid that silica is contaminating the process chemicals of the wood pulp method, the agricultural crop/residue are extracted prior to mixing with the wood pulp fibers. The extraction is conducted in an alkaline extraction process whereby silica-depleted agro-fibers and an extraction liquor comprising hemicellulose, silica, and residual alkali are recovered. At least 50%, preferably at least 70%, and most preferably at least 90% of the silica content present in the agricultural crop/residue may be removed during step c).

The alkaline solution in step c) may comprise sodium hydroxide and/or potassium hydroxide.

The initial hydroxide ion concentration in step c) may be from 0.1 to 4M, preferably from 0.15 to 3M, more preferably from 0.2 to 2M. At an end of the extraction process, it is preferable to control and verify that the pH is above 10 or above 11. The method may thus further comprise a step of:
k) verifying that the pH at the end of step c) is above 10, preferably above 11, wherein step k) occurs immediately after step c).

The ratio of the extraction liquor to the agricultural crop/residue in step c) may be from 2 to 50, preferably from 3 to 25, more preferably from 4 to 15.

A technical effect of all these features is that silica may be removed from the agro-fibers under relatively mild conditions.

The method may further comprise the step of:
l) screening and/or refining the silica-depleted agro-fibers, wherein step 1) occurs before step f). An example of refining is defibrating. A technical effect of this is that the properties of the pulp mixture may be improved and that the purity of the silica-depleted agro-fibers may be improved.

Finally, the method of the present invention may comprise a step of:
m) drying the pulp mixture.

According to a second aspect of the inventive concept, a pulp mixture manufactured by the method is provided. The pulp mixture comprises:
70-99.9% by weight of dry material of wood pulp fibers; and
0.1-30% by weight of dry material of agricultural material, the agricultural material comprising silica-depleted agro-fibers.

The pulp mixture may comprise 0.1 to 29.9%, preferably 0.5 to 25%, more preferably 1 to 20% of the silica-depleted agro-fibers.

The pulp mixture may further comprise agro-based hemicelluloses from the extraction liquor. The pulp mixture may comprise 0.1 to 5%, preferably 0.2 to 4%, more preferably 0.5 to 3% of the agro-based hemicelluloses from the extraction liquor.

According to a third aspect of the inventive concept, market pulp comprising dried pulp mixture is provided. A market pulp may be defined as a pulp produced for, and sold on, the open market, as opposed to that which is produced for internal consumption by an integrated paper mill or affiliated mill. Market pulp may be the primary ingredient used to make paper and related products.

### Definitions

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The disclosure will be described in more detail with reference to the appended schematic drawings, which show an example of a presently preferred embodiment of the disclosure.

FIG. 1a shows a flow chart for a method for production of a pulp mixture of wood pulp and agricultural material in a pulp mill with open-cycle bleach plant according to at least one example embodiment of the inventive concept;

FIG. 1b shows a flow chart for a method for production of a pulp mixture of wood pulp and agricultural material in a pulp mill with a partially closed-cycle bleach plant according to at least one example embodiment of the inventive concept;

FIGS. 2a-2c show different ways of separating the silica-depleted agro-fibers and extraction liquid prior to mixing with the wood pulp fibers according to at least one example embodiment of the inventive concept;

FIGS. 3a and 3b show flow charts for the pre-treatment of agricultural crop/residue which include screening and/or refining of the silica-depleted agro-fibers prior to mixing with the wood pulp fibers according to at least one example embodiment of the inventive concept;

FIG. 4 shows a flow chart for the pre-treatment of agricultural crop/residue which include leaching and/or washing of the silica-depleted agro-fibers prior to mixing with the wood pulp fibers according to at least one example embodiment of the inventive concept;

FIG. 5 shows a flow chart of a two-stage extraction process with countercurrent use of alkaline extraction liquid according to at least one example embodiment of the inventive concept;

### DETAILED DESCRIPTION

The present disclosure will now be described more fully hereinafter with reference to the accompanying drawings, in which currently preferred embodiments of the disclosure are shown. The present disclosure may, however, be embodied in many different forms and should not be construed as limited to the embodiments set forth herein; rather, these embodiments are provided for thoroughness and completeness, and to fully convey the scope of the disclosure to the skilled addressee.

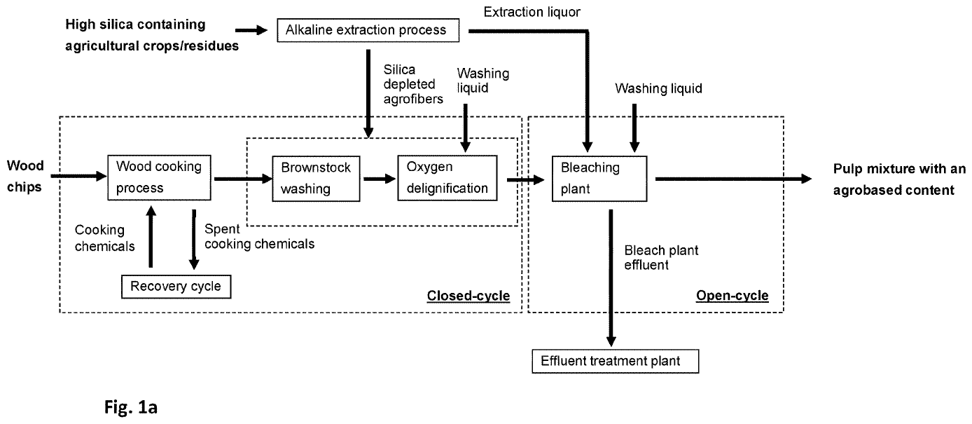

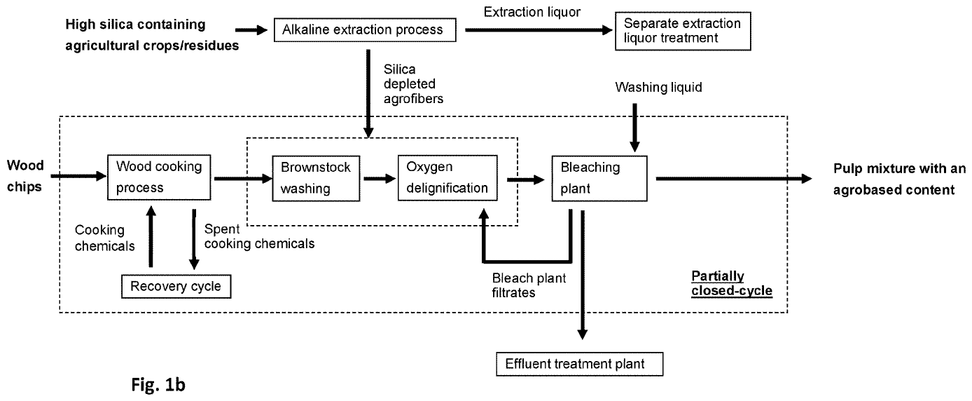

FIG. 1a illustrates a flow chart for a method for production of a pulp mixture of wood pulp and agricultural material in a pulp mill with open-cycle bleach plant according to at least one example embodiment of the inventive concept. The method may be described as kraft process with an open-cycle bleach plant.

As may be seen, the method comprises the steps of:
a) providing wood chips;
b) providing agricultural crop/residue;
c) extracting the agricultural crop/residue in an alkaline solution thus obtaining a slurry of silica-depleted agro-fibers and an extraction liquor comprising hemicellulose, silica, and residual alkali;
d) separating the silica-depleted agro-fibers from the extraction liquor;
e) liberating wood pulp fibers by treating the wood chips with cooking chemicals in a wood cooking process having a recovery cycle for cooking chemicals;
f) adding the separated silica-depleted agro-fibers to the wood pulp fibers thus obtaining a pulp mixture;
g) oxygen delignifying the liberated wood pulp fibers; and
h) bleaching the pulp mixture in a multistage bleaching sequence comprising at least one alkaline bleaching stage,
wherein steps c) and d) occur before step f) to avoid contamination of the cooking chemicals by silica from the agricultural crop/residue thereby enabling recovery of the cooking chemicals.

The raw materials for the method are wood material, such as wood chips, and agricultural crop/residue. The agricultural crop/residue may contain high levels of silica. Typically, the agricultural crop/residue may have a silica content above 1000 ppm, such as above 2000 ppm, 4000 ppm, or 10000 ppm. In order to avoid that silica is contaminating the process chemicals of the wood pulp process, the agricultural crop/residue are extracted prior to mixing with the wood pulp fibers. The extraction is conducted in an alkaline extraction process, comprising e.g. sodium hydroxide and/or potassium hydroxide as solvent, whereby silica-depleted agro-fibers and an extraction liquor comprising hemicellulose, silica, and residual alkali are recovered.

The step of extraction may be conducted with a liquor to agricultural crop/residue ratio between 2 and 50, such as between 3 to 25, or between 4 to 15. The initial hydroxide ion concentration may be between 0.1 to 4M, such as between 0.15 to 3M, or between 0.2 to 2M. At an end of the extraction process, it is preferable to control and verify that the pH is above 10 or above 11. A technical effect of these features is that silica is removed from the agro-fibers under mild conditions. The extracting may thus be conducted to remove at least 50%, preferably at least 70%, and most preferably at least 90% of the silica content present in the agricultural crop/residue. The silica-depleted agro-fibers and an extraction liquor are then separated. The silica depleted agro-fibers are added to the wood pulp fibers prior to or during step g).

It should be noted that in an open-cycle mill for bleaching effluent, the silica in the extraction liquor does not enter the closed cycle that includes the chemical cycle. The method may thus further comprise a step i) adding, during step h), the extraction liquor to the wood pulp fibers to enable simultaneous bleaching and hemicellulose sorption.

FIG. 1b illustrates a similar method as described in FIG. 1a but in a partially closed-cycle bleach plant. In a partially closed-cycle bleach plant, the washing liquids from the bleaching plant, i.e. the bleaching filtrates, are to substantial extent used as washing liquid in the pulp washing after step g). In this embodiment it is preferable not to add the extraction liquid to the bleaching plant because silicon from the extraction liquid then enters and may cause problems in the chemical recycling. The extraction liquid in this process is preferably handled separately.

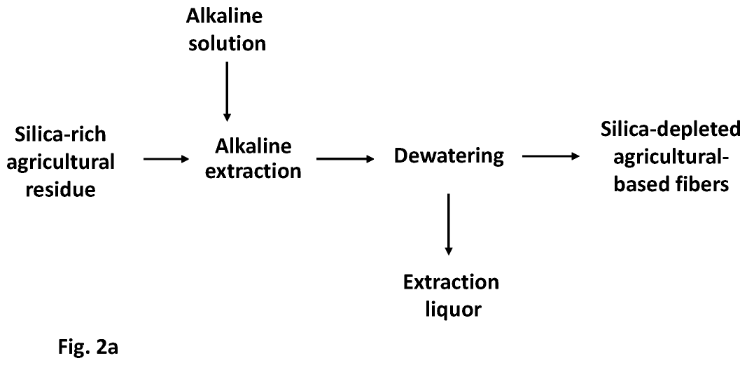

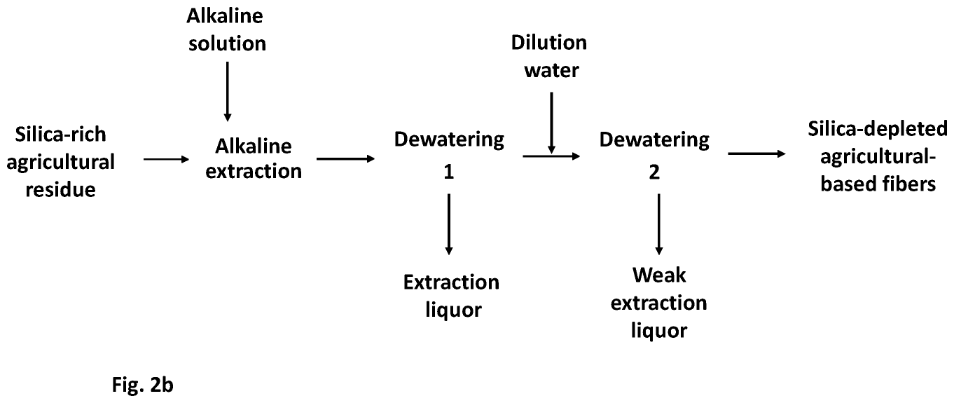

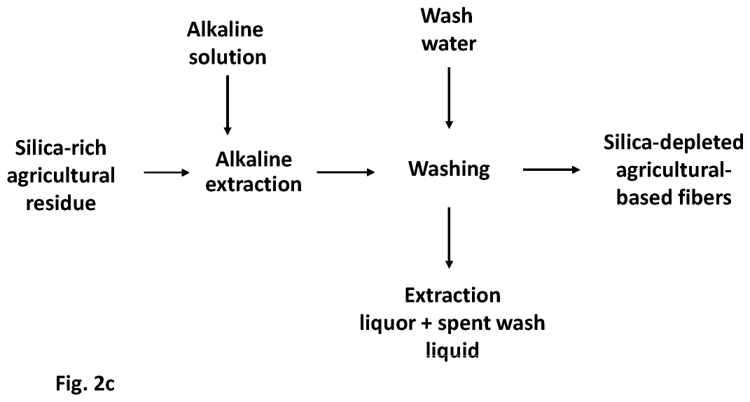

FIGS. 2a to 5 illustrate different pre-treatment steps of the agricultural crop/residue. In FIGS. 2a and 2b the extraction is followed by a separation step that includes dewatering. Additionally and/or alternatively, the separation may include washing. The silica-depleted agro-fibers and the extraction liquor may be separated in two or more steps as illustrated in FIG. 2b. In FIG. 2b, the silica-depleted agro-fibers and the extraction liquor are subjected to a first dewatering step resulting in a first purification of the silica depleted agro-fibers, followed by dilution with water, and a second dewatering step which further purifies the silica depleted agro-fibers.

In FIG. 2c, the silica-depleted agro-fibers and the extraction liquor are separated by means of washing, a so-called displacement washing, before the silica-depleted agro-fibers are added to the wood pulp fibers.

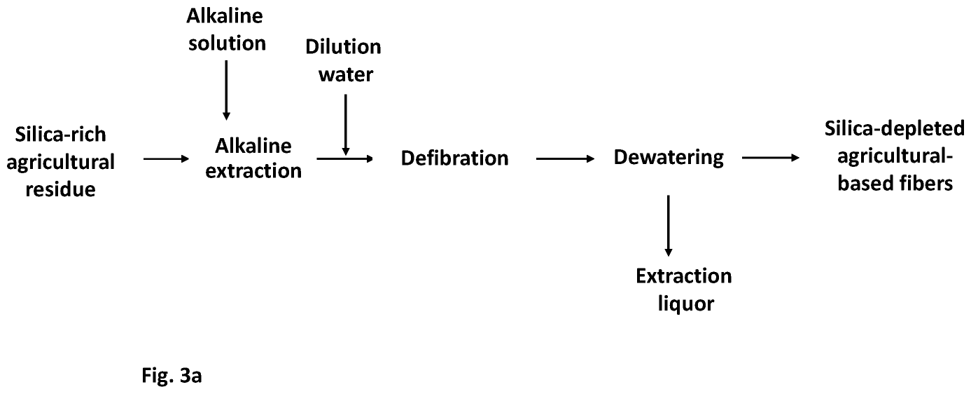

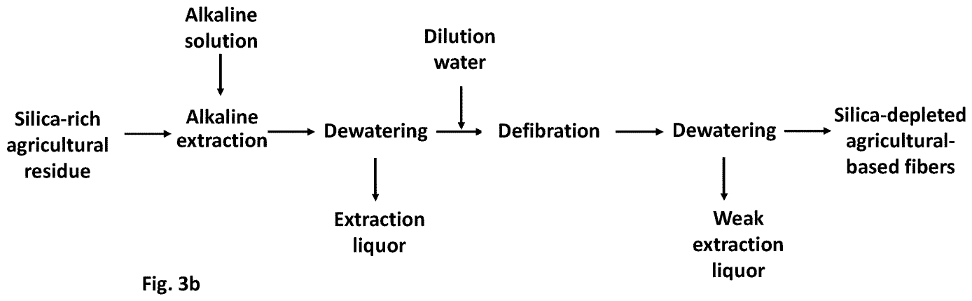

The silica depleted agro-fibers may further be subjected to screening and/or refining, such as defibrating, before step f), as illustrated in FIGS. 3a and 3b. A technical effect of this is that the properties of the pulp mixture may be improved. The screening and/or refining may be conducted either before or after step d). In FIG. 3a, the silica-depleted agro-fibers are defibrated before step d) which in this case includes dewatering. This scheme illustrates extraction and defibration method steps followed by dewatering. FIG. 3b illustrates extraction and defibration method steps with two dewatering steps. The silica-depleted agro-fibers are herein defibrated between a step of first step of dewatering and a step of second dewatering. A technical effect of screening and/or refining the silica-depleted agro-fibers is that the silica content of the fibers may be further lowered, i.e. that purer silica-depleted agro-fibers may be obtained.

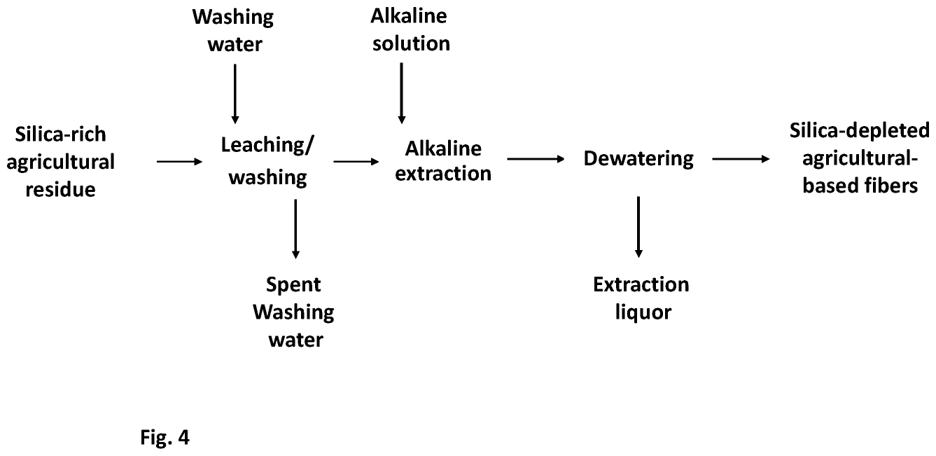

Another way to increase the purity of the silica depleted agro-fibers is to remove water soluble substances from the agricultural crop/residue prior the extraction process. This may be achieved by subjecting the agricultural crop/residue to leaching and/or washing before step c), as illustrated in FIG. 4, which illustrates washing and extraction followed by dewatering.

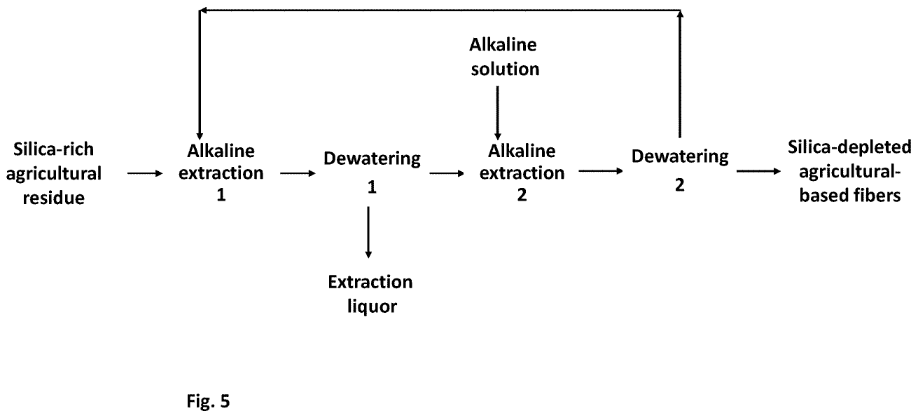

Still another way to increase the purity of the silica-depleted agro-fibers is to use a two-stage extraction process. In FIG. 5, a two-stage extraction process with countercurrent use of alkaline extraction liquid is illustrated. In a two-stage extraction process, the hydroxide ion concentration may be lower in the first alkaline extraction and higher in the second alkaline extraction. The two-stage extraction process in FIG. further comprises a first and a second step of dewatering.

In the end, the separated silica-depleted agro-fibers may typically have a silica content of no more than 3000 mg silica/kg dry material, no more than 1000 mg silica/kg dry material, or no more than 500 mg silica/kg dry material.

The separated silica-depleted agro-fibers are then added to wood pulp fibers which have been produced in a separate wood cooking process, to form a pulp mixture of wood pulp fibers and silica-depleted agro-fibers.

The wood pulping method comprises treating wood chips with cooking chemicals in a wood cooking process to liberate wood pulp fibers. For economic and environmental reasons, the wood cooking process comprises a recovery cycle for cooking chemicals. This means it is important to minimize the introduction of silica from the agricultural crop/residue which would severely disturb the process for the recycling of cooking chemicals. The liberated wood pulp fibers are then oxygen delignified and bleached in a multistage bleaching sequence comprising alkaline bleaching.

The silica-depleted agro-fibers may be added to the liberated wood pulp fibers prior to and/or during the step of oxygen delignifying. This implies the wood pulp fibers may be subjected to both oxygen delignification and bleaching together with the silica-depleted agro-fibers. In order to utilize the hemicellulose in the extraction liquor, the extraction liquor may also be added to the wood pulp fibers during the alkaline bleaching. Hereby, simultaneous bleaching of the pulp mixture and hemicellulose sorption is enabled. Moreover, the addition of the extraction liquor to the wood pulp fibers during the alkaline bleaching provides the advantage that residual alkali from the alkaline extraction process may replace fresh alkali.

It should be noted that the addition of the extraction liquor to the wood pulp fibers is preferably conducted at the earliest during the alkaline bleaching to avoid that silica is contaminating the process chemicals in for example the wood cooking process or the oxygen delignification process.

In the end, a pulp mixture may be obtained comprising 70-99.9% by weight of dry material of wood pulp fibers; and 0.1-30% by weight of dry material of agricultural material. The agricultural material may comprise silica-depleted agro-fibers, such as 0.1 to 29.9%, 0.5 to 25%, or 10 to 20% silica-depleted agro-fibers, and optionally agro-based hemicelluloses from the extraction liquor, such as 0.1 to 5%, 0.2 to 4%, or 0.5 to 3% agro-based hemicelluloses. The pulp mixture may be dried to form a market pulp.

The skilled person realizes that a number of modifications of the embodiments described herein are possible without departing from the scope of the disclosure, which is defined in the appended claims.

### EXAMPLES

### Example 1. Alkaline Extraction

Two high silica containing agricultural residues, oat hulls and wheat straw were treated by alkaline extraction to reduce the silica content of the solid residue material obtained after the extraction. 10 g raw material (based on dry solids) was treated in 190 g of alkaline solution at 85° C. for 60 minutes. The NaOH addition in the alkaline solution was varied between 1-20 weight percent based on dry matter of the agricultural residue feedstock to evaluate the effect of NaOH addition on silica content after the alkaline extraction. After the extraction, the solid residue was separated from the extraction liquor by filtration in a büchner funnel followed by displacement washing with 1 L of deionized water. Residual alkali, pH of the suspension at the end of the extraction treatment and silica content of the washed solid residue after extraction is presented in Table 1.1.

TABLE 1.1
Silica content of the raw material and results after alkaline extraction. Percent
silica removal is calculated based on the amount of silica in the solid residue after
alkaline extraction divided by the amount of silica in the feedstock material.

| | | | | | Silica | | Residual |
|---|---|---|---|---|---|---|---|
| | | | | | removal | | alkali |
| | | NaOH | | Silica | (% SiO₂ | | content ** |
| | | addition | | content * | separated | pH | (g NaOH/kg |
| Sample | | (% of raw | Yield | (mg SiO₂/kg | from raw | at | untreated |
| ID | | material) | (%) | dry sample) | material) | end | oat hulls) |
| Raw O | Oat hulls | — | — | 35 100 | — | — | — |
| | (untreated) | | | | | | |
| 1.1 | Oat hulls | 1 | 78.5 | 32 700 | 27 | 9.1 | 0 |
| 1.2 | Oat hulls | 5 | 73.0 | 22 700 | 53 | 11.7 | 0 |
| 1.3 | Oat hulls | 20 | 56.5 | 6 000 | 90 | 12.9 | 72 |
| Raw W | Wheat | — | — | 22 300 | — | — | — |
| | straw | | | | | | |
| | (untreated) | | | | | | |
| 1.4 | Wheat | 5 | 80.8 | 9 900 | 74 | 11.9 | 0 |
| | straw | | | | | | |
| 1.5 | Wheat | 20 | 64.3 | 4 000 | 91 | 13 | 86 |
| | straw | | | | | | |

* Silicon content analyzed according to an internal method KA 10.107 at More Research, MoRe Research Örnsköldsvik AB, Box 70, 891 22 Örnsköldsvik, Sweden. In this method, acid insoluble ash is determined by ISO 776. The acid insoluble ash is then treated with hydrofluoric acid (HF) and silicon content is determined by measuring the weight loss after HF-treatment. The silicon content is then calculated to silica content by multiplying the silicon content by 2.14..
** Residual alkali content analyzed according to Scan N33:94

The results of this example demonstrate that at least 90% of the silica present in the raw material (oat hulls or wheat straw) can be separated from the washed solid residue after an alkaline extraction using 20% of NaOH. Residual alkali in the extraction liquor after the alkaline extraction can be utilized to replace fresh NaOH as alkali source in alkaline bleaching. Alkali added in the extraction can therefore be used for two purposes, both to separate silica from high silica containing raw material and be used as an alkali source in alkaline bleaching steps (see Example 7).

### Example 2. Hot Water Leaching Before Alkaline Extraction

Two batches of 50 g of oat hulls (based on dry solids) were treated in a hot water leaching step before alkaline extraction to remove water soluble substances from the raw material prior to alkaline extraction. Each batch of oat hulls was mixed with deionized water at room temperature. One of the batches was adjusted to pH 3.0 after the mixing of out hulls and water by dropwise addition of sulfuric acid (19.6 g H₂SO₄/L). The leaching treatment was conducted at 10% consistency and the leaching was conducted at 85° C. for 60 minutes. After the leaching, treatment the solid residue and the liquid was left at rest for 5 minutes to let the solid residue sediment followed by decantation of 250 mL of liquid. 500 mL of deionized water was added and left for 5 minutes followed by decantation of 500 mL of liquid. Thereafter the solid residue was filtered and washed with 1 L of deionized water.

The washed solid residue from the leaching step was further treated by alkaline extraction using same conditions as Example 1. The sodium hydroxide addition was 30 weight percent based on the dry weight of the untreated oat hulls before leaching treatment. After extraction the solid residue was separated from the extraction liquor by filtration. The solid residue was dispersed in 1 L of deionized water for 5 minutes and filtered followed by displacement washing with 1 L of deionized water. The results of metal and starch content analyses are shown in Table 2.1.

TABLE 2.1
Iron, manganese, phosphorus, silica and starch content
of the raw material and treated samples.

| | | | | | Silica | |
|---|---|---|---|---|---|---|
| | | Fe* | Mn* | P* | content** | Starch |
| Sample | | (mg/kg dry | (mg/kg dry | (mg/kg dry | (mg/kg dry | content*** |
| ID | | sample) | sample) | sample) | sample) | (%) |
| Raw O | Oat hulls | 56.2 | 44.9 | 1 900 | 35 100 | 7.9 |
| | (untreated) | | | | | |
| 2.1 | Hot water | 24.8 | 26.3 | 622.0 | 38 100 | 1.1 |
| | leaching | | | | | |
| 2.2 | Hot water | 22.4 | 9.4 | 438.0 | 38 300 | 3.0 |
| | leaching | | | | | |
| | (pH 3) | | | | | |

*Fe, Mn and P contents analyzed according to SCAN-CM 38
**Silicon content analyzed according to an internal method KA 10.107 at More Research, MoRe Research Örnsköldsvik AB, Box 70, 891 22 Örnsköldsvik, Sweden. In this method, acid insoluble ash is determined by ISO 776. The acid insoluble ash is then treated with hydrofluoric acid (HF) and silicon content is determined by measuring the weight loss after HF-treatment. The silicon content is then calculated to silica content by multiplying the silicon content by 2.14. .
***Starch content analyzed according to AOAC Official Method 996.11 (but without predilution with NaOH or DMSO so the analysis result does not include “resistent starch”). The analysis was performed by Eurofins Food & Feed Testing Norway AS (Chemistry) Møllebakken 40, NO-1538 Moss

This example shows that hot water leaching or hot water leaching at acidic pH (starting pH of 3) is not a suitable method to reduce silica content of the solid residue. On the other hand, an advantage of using a leaching step is that the content of other metal ions in the solid residue is reduced for example Iron (Fe), Manganese (Mn) and Phosphorous (P). These metals belong to the group of unwanted non-process elements in the kraft process, and it is desirable to limit the amount of non-process elements entering the process. Introduction of P into the recovery cycle of a kraft pulp mill should be minimized to avoid accumulation in the recovery cycle. Catalytically active metal ions such as Fe and Mn degrades peroxide during alkaline bleaching with peroxide and to minimize reduction of pulp viscosity during bleaching, high concentrations of these metal ions should be avoided. The use of a washing or leaching treatment with liquid separation prior to alkaline extraction can therefore be utilized to reduce the introduction of non-process elements into the kraft process.

The content of starch in the solid residue is also significantly reduced by the hot water leaching treatment performed at neural or acidic conditions as shown in Table 2. The reduction of starch content before the alkaline extraction is beneficial to reduce the alkali consumption during the extraction step, which will be shown in Example 3.

### Example 3. Alkaline Extraction after Hot Water Leaching

Alkaline extraction was conducted using the same procedure as in Example 1. The starting materials was untreated oat hulls and two pre-treated samples which had been leached in hot water according to the procedure described in Example 2.

In Table 3.1, the residual alkali contents and alkali consumption after extraction are shown with or without hot water leaching.

TABLE 3.1
NaOH addition of the alkali extraction, residual alkali content
after extraction and alkali consumption. All numbers in the table
are calculated as percentage of dry untreated raw material.

| | Pre-treatments | NaOH | Residual | Alkali |
|---|---|---|---|---|
| Sample | before alkaline | addition | alkali* | consumption |
| ID | extraction | (%) | (%) | (%) |
| 3.1 | No leaching | 20 | 7.4 | 12.6 |
| 3.2 | Hot water leaching | 20 | 9.4 | 10.6 |
| 3.3 | Hot water leaching | 20 | 9.5 | 10.5 |
| | (starting pH 3) | | | |

*Residual alkali content analyzed by standard method Scan N33:94

This example demonstrates that the alkali consumption during extraction can be significantly reduced by using a leaching treatment combined with liquid separation (decantation/washing) prior to alkaline extraction.

### Example 4. Defibration and Screening after Alkaline Extraction

The solid residue materials collected after the alkaline extractions in Example 3 were further treated by defibration using a Waring blender (model HGBTWTG4, 400 W). The defibration was performed during 120 seconds/batch, at full speed (H1), using 3% consistency and 500 ml suspension per batch in order to individualize/liberate agricultural-based agro-fibers from the extracted samples ID 3.1-3.3. After defibration, all the batches obtained from the same sample were mixed in a large plastic bucket.

The need for a defibration treatment is dependent on the conditions used during alkaline extraction. The delignification of the material is critically for the ease of defibration. An extensively delignified material may not need any other defibration treatment in an industrial process other than the shear forces which is already present in the process (e.g. pumps and high intensity steam mixers). A less delignified material may require a dedicated defibration equipment, such as a refiner or a high-speed disperser.

After defibration, coarse non-defibrated material was separated by adding the suspension to a laboratory-sized pressure-screen (Metso Power) with a 0.2 mm slot screen. About 90% of the treated material was collected as accept while 10% was collected in the reject fraction (coarse non-defibrated material). In an industrial process, the reject would be recirculated to the alkaline extraction step or the defibration step to avoid losses of agro-fiber material. The accept fraction was dewatered using a büchner funnel to about 20% consistency. The result after the treatment is shown in Table 4.1.

TABLE 4.1
Iron, manganese, phosphorus, silica (silicon-based compounds calculated
as SiO₂) and starch content of the defibrated and screened samples. All
samples were extracted before defibration and screening and for sample
4.2 and 4.3 hot water leaching was performed prior to extraction.

| | | | | | Silica | |
|---|---|---|---|---|---|---|
| | Treatments | Fe* | Mn* | P* | content | Starch |
| Sample | before | (mg/kg dry | (mg/kg dry | (mg/kg dry | (mg SiO₂/kg | content |
| ID | defibration | sample) | sample) | sample) | dry sample) | (%) |
| 4.1 | No leaching | 4 | 30 | 51 | 1 120 | n.a. |
| 4.2 | Hot water | 14 | n.a. | 40 | 360 | n.a. |
| | leaching | | | | | |
| 4.3 | Hot water | 12.8 | 7.5 | 7.1 | 770 | 0.0 |
| | leaching | | | | | |
| | (pH 3) | | | | | |

*Fe, Mn and P contents analyzed according to SCAN-CM 38
**Silicon content analyzed according to an internal method KA 10.107 at More Research, MoRe Research Örnsköldsvik AB, Box 70, 891 22 Örnsköldsvik, Sweden. In this method, acid insoluble ash is determined by ISO 776. The acid insoluble ash is then treated with hydrofluoric acid (HF) and silicon content is determined by measuring the weight loss after HF-treatment. The silicon content is then calculated to silica content by multiplying the silicon content by 2.14..
***Starch content analyzed according to AOAC Official Method 996.11 (but without predilution with NaOH or DMSO so the analysis result does not include “resistent starch”). The analysis was performed by Eurofins Food & Feed Testing Norway AS (Chemistry) Møllebakken 40, NO-1538 Moss

The procedure used in Example 4, i.e. including a defibration step with subsequent liquid separation, was found to be surprisingly efficient to further reduce the silica content of the agricultural-based fibers. The silica content of the agricultural-based fibers after defibration and screening was at about the same level or lower than the silica content of industrial softwood kraft pulp fibers collected after brown stock washing at the last wash press before oxygen delignification (about 30% pulp consistency). A sample of this pulp was taken out and was further laboratory washed by dilution with water to 2-3% pulp consistency followed by 30 minutes leaching in a plastic bucket. 10 L of this pulp suspension was then dewatered in a nylon cloth bag (100 mesh) to about 15-20% pulp consistency, washed with 20 L of water, centrifuged to about 35% consistency and finally washed again with 20 L of water and centrifuged to about 35% consistency. This sample of liberated wood pulp fibers (Sample ID 4.4) had a silica content of 750 mg silica (Si content recalculated to SiO₂ content) after laboratory washing of the pulp.

### Example 5. Addition of Silica-Depleted Agro-Fibers in Oxygen Delignification

The sample of liberated wood pulp fibers (ID 4.4) collected and washed in Example 4 and the silica-depleted agro-fibers obtained in Example 4 ID 4.1 and ID 4.2) were used in oxygen delignification trials.

Pulp mixtures composed by 15% silica-depleted agro-fibers and 85% of wood pulp fibers (ID 4.4) was prepared. To the pulp mixtures a liquid solution with 35 g NaOH/kg pulp (g per kg of 100% dry pulp), 5 g MgSO₄/kg pulp (g per kg of 100% dry pulp) and water was added so that a pulp consistency of 10% was obtained. The pulp suspensions were charged into steel autoclaves, oxygen gas was added to a pressure of 15 bars and the autoclaves were inserted into a hot-air oven (CRS Reactor Engineering AB, Stenkullen, Sweden). A two-stage oxygen delignification was performed, first stage was performed at 90° C. and the second stage at 100° C., in between the two stages the pressure in the autoclaves was reduced to 5 bars. A 40-minute temperature ramp and 30 minutes residence time at full temperature was used during the first stage. For the second stage a 10-minute temperature ramp and 60 minutes residence time at full temperature was used. Kappa number, pulp viscosity and arabinoxylan content were analyzed after oxygen delignification, see results in Table 5.1.

TABLE 5.1
Results after oxygen delignification (OD). The arabinoxylan content is reported
as the sum of xylan and arabinan contents (anhydro sugars) based on chemical
composition including klason lignin, acid soluble lignin and ash content.

| | | Wood pulp | | Pulp | Pulp | Arabinoxylan |
|---|---|---|---|---|---|---|
| Sample | Agro-based | fibers | Kappa | brightness | viscosity | content **** |
| ID | additions | ID 4.4 | number* | (% ISO) | (dm3/kg) | (%) |
| 4.4 | Wood pulp | | 27.9 | 26.2 | 1144 | 8.8 |
| | fibers (before | | | | | |
| | OD) | | | | | |
| 5.2 | Reference | 100% | 9.8 | 46.2 | 862 | 8.8 |
| 5.3 | 15% agrofiber | 85% | 12.7 | 44.9 | 869 | 12.4 |
| | (ID: 4.1) | | | | | |
| 5.4 | 15% agrofiber | 85% | 12.2 | 45.0 | 876 | 12.9 |
| | (ID: 4.2) | | | | | |
| 5.5 | 15% agrofiber | 85% | 12.6 | 45.1 | 869 | 13.0 |
| | (ID: 4.2) + | | | | | |
| | extraction | | | | | |
| | liquor in EP | | | | | |

*Kappa number analyzed by standard method SS-ISO 302: 2016
**Pulp brightness analyzed by standard method ISO 3688 and SS ISO 2470-1
*** Pulp viscosity analyzed by standard method ISO SS-ISO 5351: 2010
**** Arabinoxylan content based on the anhydrosugar contents of arabinan + xylan, carbohydrate analysis analyzed by standard method ISO 21437: 2020. Klason lignin and acid soluble lignin (ISO 21436: 2020) and ash content (ISO-1762: 2019) was included in the total mass balance to calculate the sugar contents.

The oxygen delignified pulps with agro-fibers had a significantly higher arabinoxylan content, sample ID 5.4 and ID 5.5 was prepared by the same procedure so far since the addition of extraction liquor is made later in the EP step during bleaching.

The oxygen delignified pulp mixture was then bleached in laboratory bleaching trials using a Do-EP-D/Q-PO bleaching sequence. Between each bleaching step the pulps were washed with water.

The Do step (chlorine dioxide step) was performed at 70° C. at 10% pulp consistency for 60 minutes in plastic bags submerged into a temperature regulated water bath. The chlorine dioxide addition was based on a constant charge factor of 2.0. The charge factor of active chlorine as chlorine dioxide in DO corresponds to 20/10=2.0 (20 g active chlorine per kg dry pulp for a pulp with kappa number 10). Additionally 0.4 g NaOH/kg pulp (g per kg 100% dry pulp) was added for pH adjustment.

The EP step was performed at 85° C. at 10% pulp consistency for 80 minutes in plastic bags submerged into a temperature regulated water bath. The H₂O₂, NaOH and MgSO₄ charges were 3.0, 8.5 and 1.0 g/kg pulp (g per kg 100% dry pulp), respectively. Kappa number, brightness and pulp viscosity were analyzed after EP-bleaching, see results in Table 5.2.

TABLE 5.2
Results after EP-bleaching.

| | | | Pulp | Pulp |
|---|---|---|---|---|
| Sample | | Kappa | brightness** | viscosity*** |
| ID | Agro-based additions | number* | (% ISO) | (dm3/kg) |
| 5.6 | Reference | 2.9 | 77.0 | 875 |
| 5.7 | 15% agrofiber (ID: 4.1) | 3.0 | 77.1 | 891 |
| 5.8 | 15% agrofiber (ID: 4.2) | 3.1 | 76.6 | 889 |
| 5.9 | 15% agrofiber (ID: 4.2) + extraction liquor in EP | 2.9 | 77.9 | 881 |

*Kappa number analyzed by standard method SS-ISO 302: 2016
** Pulp brightness analyzed by standard method ISO 3688 and SS ISO 2470-1
***Pulp viscosity analyzed by standard method ISO SS-ISO 5351: 2010

It can be noted that the pulp properties after the EP step was quite similar for all four pulp samples without any large variations. The increased chlorine dioxide charge (constant kappa factor) in the Do step compensated for the higher kappa number of the pulps with agricultural-based additions recovered after oxygen delignification.

The D/Q step (Chlorine dioxide bleaching step with a subsequent EDTA treatment without washing in between) was performed at 75° C. at 10% pulp consistency for 90 minutes in plastic bags submerged into a temperature regulated water bath in the D-step. The chlorine dioxide charge was 1.9 g/kg (g per kg 100% dry pulp, corresponds to 5 g of active chlorine per kg pulp). Directly after the D-step, 0.5 g EDTA/kg pulp (g per kg 100% dry pulp) and 2.2 g NaOH/kg pulp (g per kg 100% dry pulp) were added to the pulp and allowed to react for 5 minutes before washing the pulp.

The last bleaching step, the PO step (pressurized peroxide bleaching), was performed at 100° C. at 10% pulp consistency in steel autoclaves introduced into a temperature regulated bath with polyethylene glycol. A 15-minute temperature ramp was used followed by 120 minutes residence time at 100° C. The H₂O₂, NaOH and MgSO₄ charges were 5.0, 7.5 and 1.0 g/kg pulp (g per kg 100% dry pulp), respectively. Brightness, viscosity and arabinoxylan content were analyzed after PO-bleaching, see results in Table 5.3.

TABLE 5.3
Results after PO-bleaching. The arabinoxylan content is reported as the
sum of xylan and arabinan contents (anhydro sugars) based on chemical composition
including klason lignin, acid soluble lignin and ash content.

| | | Pulp | Pulp | Arabinoxylan |
|---|---|---|---|---|
| Sample | | brightness* | viscosity** | content*** |
| ID | Agro-based additions | (% ISO) | (dm3/kg) | (%) |
| 5.10 | Reference | 89.4 | 862 | 8.2 |
| 5.11 | 15% agrofiber (ID: 4.1) | 89.4 | 869 | 12.2 |
| 5.12 | 15% agrofiber (ID: 4.2) | 88.9 | 876 | 12.2 |
| 5.13 | 15% agrofiber (ID: 4.2) + extraction liquor to EP | 88.9 | 869 | 12.7 |

*Pulp brightness analyzed by standard method ISO 3688 and SS ISO 2470-1
**Pulp viscosity analyzed by standard method ISO SS-ISO 5351: 2010
***Arabinoxylan content based on the anhydrosugar contents of arabinan + xylan, carbohydrate analysis analyzed by standard method ISO 21437: 2020. Klason lignin and acid soluble lignin (ISO 21436: 2020) and ash content (ISO-1762: 2019) was included in the total mass balance to calculate the sugar contents.

The results demonstrate that the pulp mixtures with agro-based additions can be bleached to full brightness (i.e. brightness>88.5) and maintaining the same pulp viscosity after bleaching as the reference pulp. The increased arabinoxylan content of the pulps with agro-based fiber additions, ID 5.11 and ID 5.12 compared to the reference pulp ID 5.10, is maintained after bleaching.

The pulp with addition of extraction liquor during the EP step, ID 5.13, shows that arabinoxylan from the extraction liquor to a high extent is sorbed on the pulp during the EP-stage and remains on the pulp after the final bleaching step. The sorbed arabinoxylan (from the extraction liquor) contributes to a significant increase of about 0.5% in total pulp yield. In industrial scale this means that by adding the extraction liquor in an alkaline bleaching step of an open-cycle bleaching plant, arabinoxylan from the extraction liquor can be retained in the pulp mixture without taking the risks and drawbacks of introducing large amount of silica into the recovery cycle of the kraft pulp mill.

### Example 6. Paper Properties of Pulps with Addition of Silica-Depleted Agro-Fibers in Oxygen Delignification

The fully bleached pulps prepared in Example 5 were pH adjusted to pH 5.5-6.0 and then formed into paper sheets with a basis weight of about 370 g/m² using a laboratory sheet former. The formed laboratory sheets were pressed twice for 10 minutes at 50 bars pressure. The pressed sheets were dried at 90° C. and at 90% relative humidity for 60 minutes.

The once-dried pulps were wet disintegrated in accordance with standard method ISO 5263-1:2004. Laboratory hand sheets was prepared from unbeaten pulp and pulp beaten 2000 revolutions using a PFI mill. The PFI beating was performed in accordance with standard method SS-EN ISO 5264-2:2011. Hand sheet with a basis weight of about 60 g/m² was formed and pressed in accordance with standard method EN ISO 5269-1. The pressed hand sheets were dried and conditioned in a climate room for at least 24 hours at 23±1° C. and 50±2% relative humidity in accordance with standard method EN ISO 20187.

Tensile index was tested using a Lorentzen & Wettre tensile tester apparatus, basis weight of the hand sheets was measured in accordance with standard method ISO 536:2012 and ISO 5269-1:2005 and tensile index was tested in accordance with standard method ISO 1924-3. The result from tensile strength tests is shown in Table 6.1.

TABLE 6.1
Tensile index testing results of unbeaten and beaten pulps

| | | Produced | | PFI 2000 |
|---|---|---|---|---|
| Sample | Agro-based | from | Unbeaten | revolutions |
| ID | additions | sample ID | (kNm/kg) | (kNm/kg) |
| 6.1 | Reference | 5.10 | 23.7 | 80.9 |
| 6.2 | 15% agrofiber | 5.11 | 26.4 | 84.0 |
| 6.3 | 15% agrofiber | 5.12 | 29.1 | 83.8 |
| 6.4 | 15% agrofiber + | 5.13 | 24.8 | 86.5 |
| | extraction | | | |
| | liquor in EP | | | |

As shown in Table 6.1, tensile index was increased for all samples when agro-fibers were added in the oxygen delignification and for the sample with extraction liquor added during alkaline bleaching. The results show that the procedures used in Example 5 can be utilized to make a paper pulp with improved strength properties compared to a standard pulp product based on 100% of wood feedstock.

### Example 7. Addition of Extraction Liquor in Alkaline Bleaching

A sample of oxygen delignified industrial softwood kraft pulp was collected at the wash press after oxygen delignification (about 30% pulp consistency). This pulp was further laboratory washed by dilution with water to 2-3% pulp consistency followed by 30 minutes leaching in a plastic bucket. 10 L of this pulp suspension was then dewatered in a nylon cloth bag (100 mesh) to about 15-20% pulp consistency, washed with 20 L of water and centrifuged to about 35% consistency. This sample of oxygen delignified wood pulp fibers (Sample ID 7.1) had a silica content of 289 mg silica/kg of dry sample (Si content recalculated to SiO₂ content) after laboratory washing of the pulp.

This pulp was laboratory bleached according to the same procedures and conditions as in Example 5 using a Do-EP-D/Q-PO sequence, except that no additions of agro-fibers were made. The charge of chlorine dioxide in the Do-step was the same for both samples. One reference sample was bleached and one sample in which 1.1 kg extraction liquor/kg of pulp (kg per kg of 100% dry pulp) was added in the EP-bleaching step. The extraction liquor used was recovered after the alkaline extraction of sample ID 4.3. The arabinoxylan content in the extraction liquor was 8.7 g/kg of extraction liquor and residual alkali content was 10.6 g/kg. 100% of the NaOH charge in the EP-step was replaced by residual alkali in the extraction liquor. 0.36 g H₂SO₄ was added per kilogram of pulp in the EP step to obtain same alkali charge as for the reference sample. The addition level of extraction liquor could be reduced to avoid the use of sulfuric acid addition to the EP-step if needed. Results after EP-bleaching is shown in Table 7.1.

TABLE 7.1
Results after EP step

| | | | Pulp | Pulp | Arabinoxylan |
|---|---|---|---|---|---|
| Sample | | Kappa | brightness** | viscosity*** | content**** |
| ID | Agro-based additions | number* | (% ISO) | (dm3/kg) | (%) |
| 7.2 | Reference | 3.2 | 76.6 | 879 | 9.3 |
| 7.3 | Extraction liquor in EP | 3.2 | 77.0 | 882 | 9.7 |

*Kappa number analyzed by standard method SS-ISO 302: 2016
**Pulp brightness analyzed by standard method ISO 3688 and SS ISO 2470-1
***Pulp viscosity analyzed by standard method ISO SS-ISO 5351: 2010
****Arabinoxylan content based on the anhydrosugar contents of arabinan + xylan, carbohydrate analysis analyzed by standard method ISO 21437: 2020. Klason lignin and acid soluble lignin (ISO 21436: 2020) and ash content (ISO-1762: 2019) was included in the total mass balance to calculate the sugar contents.

After the EP-bleaching step it can be noted that the arabinoxylan content in the pulp was increased by 0.5% due to xylan sorption taking place, while bleaching results was about same as for the reference. Results after the PO-step is shown in Table 7.2.

TABLE 7.2
Results after PO step

| | | Pulp | Pulp | Arabinoxylan |
|---|---|---|---|---|
| Sample | Agro-based | brightness** | viscosity*** | content **** |
| ID | additions | (% ISO) | (dm3/kg) | (%) |
| 7.4 | Reference | 91.2 | 861 | 8.9 |
| 7.5 | Extraction | 91.0 | 811 | 9.4 |
| | liquor in EP | | | |

*Pulp brightness analyzed by standard method ISO 3688 and SS ISO 2470-1
**Pulp viscosity analyzed by standard method ISO SS-ISO 5351: 2010
*** Arabinoxylan content based on the anhydrosugar contents of arabinan + xylan, carbohydrate analysis analyzed by standard method ISO 21437: 2020. Klason lignin and acid soluble lignin (ISO 21436: 2020) and ash content (ISO-1762: 2019) was included in the total mass balance to calculate the sugar contents.

The results show that the same brightness was obtained for both samples and that the arabinoxylan content was increased by 0.5% after bleaching when adding extraction liquor obtained after alkaline extraction. Furthermore, this corresponds to an increase in pulp yield by about 0.5%.

### Example 8. Paper Properties of Pulp with Addition of Extraction Liquor in EP-Bleaching Step

Laboratory hand sheets was produced from the PO-bleached samples prepared in Example 7, i.e. ID 7.4 and ID 7.5, using the same methods and analyses as in Example 6. Results from tensile strength testing are shown in Table 8.1.

TABLE 8.1
Tensile index results of unbeaten and beaten pulps

| | | | | PFI 2000 |
|---|---|---|---|---|
| Sample | Agro-based | Produced from | Unbeaten | revolutions |
| ID | additions | sample ID | (kNm/kg) | (kNm/kg) |
| 7.6 | Reference | 7.4 | 21.2 | 77.6 |
| 7.7 | Extraction liquor | 7.5 | 27.2 | 81.2 |
| | in EP | | | |

The results show that tensile index is significantly increased when extraction liquor is added to the EP-step.

### Example 9. Silica Intake into the Closed-Cycle of the Kraft Pulp Mill

The efficiency of silica removal during the alkaline extraction process can be used to limit and control the intake of silica into the closed-cycle of the kraft pulp mill. An insufficient pre-processing of a high silica containing agricultural crop/residue material will result in a very high intake of silica, which will give high risks of, for example, scaling in the evaporation and accumulation of silica in the lime cycle. In Table 9.1, examples of the maximum silica intake are shown based on the assumption that 100% of the silica in the agricultural-based fibers ends up in the chemical recovery cycle of the pulp mill.

TABLE 9.1
Maximum silica intake (g silica/air dry ton pulp, 10% moisture
content) into the closed-cycle of a kraft pulp mill due to the
addition of agro-fibers after pretreatment of oat hulls. The
data in the table are calculated based on silica content of
samples from Example 1 and 4, plus a theoretical example without
any liquor separation after the alkaline extraction.

| | Theoretical | | | | |
|---|---|---|---|---|---|
| | example (no | Sample | Sample | Sample | Sample |
| Agro-fibers | liquor | ID 1.3 | ID 4.1 | ID 4.2 | ID 4.3 |
| in the pulp | separation) * | (g SiO₂/ | (g SiO₂/ | (g SiO₂/ | (g SiO₂/ |
| mixture (%) | (g SiO₂/ADT) | ADT) | ADT) | ADT) | ADT) |
| 5 | 1580 | 270 | 50 | 16 | 35 |
| 10 | 3159 | 540 | 101 | 32 | 69 |
| 15 | 4739 | 810 | 151 | 49 | 104 |
| 30 | 9477 | 1620 | 302 | 97 | 208 |

* Theoretical example based on silica content in the feedstock and assuming a 50% gravimetrical yield of agro-fibers after the alkaline extraction step

For comparison purposes, the silica content of an industrial softwood kraft pulp taken out in brownstock washing before oxygen delignification (Sample ID 4.4) had a silica content of 750 g SiO₂/air dry ton pulp (10% moisture content in the pulp).

This example demonstrates that with efficient pretreatment the amount of silica which is added to the oxygen delignification step (together with the agro-fibers) can be limited. The critical silica level is mill dependent, but it is advantageous to keep silica content of the agro-fibers low to enable a high addition level of agro-fibers without creating problems related to accumulation of silica in the chemical recovery cycle.

If both agro-fibers and the extraction liquor from a high silica containing feedstock are added to the closed-cycle of the kraft pulp mill, e.g. before or during the wood cooking process or in the oxygen delignification step, a very large amount of silica would be introduced. Such a procedure would be technically unviable and economically unsustainable in a kraft pulp mill with a chemical recovery cycle.

1. A method for production of a pulp mixture of wood pulp and agricultural material, said method comprising the steps of:
a) providing wood chips;
b) providing agricultural crop/residue;
c) extracting said agricultural crop/residue in an alkaline solution thus obtaining a slurry of silica-depleted agro-fibers and an extraction liquor comprising hemicellulose, silica, and residual alkali;
d) separating said silica-depleted agro-fibers from said extraction liquor;
e) liberating wood pulp fibers by treating said wood chips with cooking chemicals in a wood cooking process having a recovery cycle for cooking chemicals;
f) adding said separated silica-depleted agro-fibers to said wood pulp fibers thus obtaining a pulp mixture;
g) oxygen delignifying said liberated wood pulp fibers; and
h) bleaching said pulp mixture,
wherein said steps c) and d) occur before said step f) to avoid contamination of the cooking chemicals by silica from the agricultural crop/residue thereby enabling recovery of said cooking chemicals, and
wherein said extraction liquor is handled separately,
or the method further comprises the step:
i) adding, at the earliest during step h), said extraction liquor to said wood pulp fibers to enable simultaneous bleaching and hemicellulose sorption.

2. The method according to claim 1, wherein said agricultural crop/residue have a silica content of at least 1000 ppm, preferably at least 2000 ppm, more preferably at least 4000 ppm, most preferably at least 10000 ppm.

3. The method according to claim 1, wherein said silica-depleted agro-fibers are added to said wood pulp fibers prior to or during step g).

4. The method according to claim 1, wherein step d) comprises dewatering and/or washing said slurry of silica-depleted agro-fibers and extraction liquor.

5. The method according to claim 1, further comprising the step of:
j) leaching and/or washing said agricultural crop/residue to remove water soluble elements from said agricultural crop/residue,
wherein step j) occurs before step c).

6. The method according to claim 1, wherein said silica-depleted agro-fibers comprise no more than 3000 mg silica/kg dry material, preferably no more than 1000 mg silica/kg dry material, more preferably no more than 500 mg silica/kg dry material.

7. The method according to claim 1, wherein at least 50%, preferably at least 70%, and most preferably at least 90% of the silica content present in said agricultural crop/residue is removed during step c).

8. The method according to claim 1, wherein said alkaline solution in step c) comprises sodium hydroxide and/or potassium hydroxide.

9. The method according to claim 1, wherein initial hydroxide ion concentration in step c) is from 0.1 to 4M, preferably from 0.15 to 3M, more preferably from 0.2 to 2M.

10. The method according to claim 1, further comprises a step of:
k) verifying that the pH at the end of step c) is above 10, preferably above 11, wherein step k) occurs immediately after step c).

11. The method according to claim 1, wherein ratio of said extraction liquor to said agricultural crop/residue in step c) is from 2 to 50, preferably from 3 to 25, more preferably from 4 to 15.

12. The method according to claim 1, further comprising the step of:
l) screening and/or refining said silica-depleted agro-fibers,
wherein step l) occurs before step f).

13. The pulp mixture manufactured by the method according to claim 1, said pulp mixture comprising:
70-99.9% by weight of dry material of wood pulp fibers; and
0.1-30% by weight of dry material of agricultural material, said agricultural material comprising silica-depleted agro-fibers.

14. The pulp mixture according to claim 13, wherein said pulp mixture comprises 0.1 to 29.9%, preferably 0.5 to 25%, more preferably 1 to 20% of said silica-depleted agro-fibers.

15. The pulp mixture according to claim 13, wherein said pulp mixture further comprises agro-based hemicelluloses from said extraction liquor.

16. The pulp mixture according to claim 15, wherein said pulp mixture comprises 0.1 to 5%, preferably 0.2 to 4%, more preferably 0.5 to 3% of said agro-based hemicelluloses from said extraction liquor.

17. A market pulp comprising dried pulp mixture according to claim 13.

18. The method according to claim 1, wherein the pulp mixture is bleached in a multistage bleaching sequence comprising at least one alkaline bleaching stage.
